(19) United States
(12) Patent Application Publication
(10) Pub. No.: US 2009/0222604 A1
(43) Pub. Date: Sep. 3, 2009

(54) USB DEVICE, PRINTING APPARATUS, CONTROL METHOD OF USB DEVICE, AND PROGRAM THEREFOR

(75) Inventor: Hideki Morozumi, Okaya-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/395,377

(22) Filed: Feb. 27, 2009

(30) Foreign Application Priority Data
Feb. 29, 2008 (JP) 2008-050062

(51) Int. Cl. G06F 13/14

(52) U.S. Cl. 710/106

(57) ABSTRACT

A USB device having functions of USB host and USB device, comprising: a wireless unit that wirelessly performs both transmission/reception of data to/from a USB host side apparatus and transmission/reception of data to/from a USB device side apparatus; an information storage unit that stores communication information on transmission and reception conditions for the USB host side apparatus; and a communication control unit that causes the wireless unit to release a connection with the USB host side apparatus during an execution period based on a period for which the wireless unit serving as a USB host transmits/receives predetermined processing data to/from the USB device side apparatus and a data processing executing unit executes predetermined data processing using the processing data and that causes the wireless unit to perform reconnection with the USB host side apparatus using the communication information stored in the information storage unit after the data processing executing unit has ended the data processing.

### BACKGROUND

1. Technical Field

The present invention relates to a USB device, a printing apparatus, a control method of a USB device, and a program therefor.

2. Related Art

A USB device that is provided in an image output device and has a function of a host wire adapter, which performs data exchange between a USB device class and the image output device and data exchange between the image output device and a USB host class, in a wireless USB is proposed in the related art (for example, refer to JP-A-2007-48029). The USB device disclosed in JP-A-2007-48029 allows a USB host side apparatus and a USB device side apparatus to perform exchange of information through one wireless USB interface.

The image output device provided with the USB device disclosed in JP-A-2007-48029 operates as both a USB device and a USB host. Here, when transmission/reception of data to/from either a USB device side apparatus or a USB host side apparatus is performed, the image output device may perform predetermined processing (for example, printing) using the data. In this case, the USB device side apparatus and the USB host side apparatus are not physically connected to each other in the wireless USB. Accordingly, a problem of how to transmit and receive data occurs. In such a case, it is requested to smoothly perform data communication with the USB host side apparatus or the USB device side apparatus.

### SUMMARY

An advantage of some aspects of the invention is that it provides a USB device, a printing apparatus, a control method of a USB device, and a program therefor capable of more smoothly performing wireless data communication with a USB host side apparatus or a USB device side apparatus.

According to an aspect of the invention, a USB device having functions of USB host and USB device includes: a wireless unit that wirelessly performs both transmission/reception of data to/from a USB host side apparatus and transmission/reception of data to/from a USB device side apparatus; an information storage unit that stores communication information on transmission and reception conditions for the USB host side apparatus; and a communication control unit that causes the wireless unit to release a connection with the USB host side apparatus during an execution period based on a period for which the wireless unit serving as a USB host transmits/receives predetermined processing data to/from the USB device side apparatus and a data processing executing unit executes predetermined data processing using the processing data and that causes the wireless unit to perform reconnection with the USB host side apparatus using the communication information stored in the information storage unit after the data processing executing unit has ended the data processing.

In the USB device, a connection with the USB host side apparatus is released during the execution period based on a period for which predetermined processing data is transmitted/received to/from the USB device side apparatus serving a USB host and predetermined data processing is executed by using the processing data, and reconnection with the USB host side apparatus is performed by using the stored communication information on transmission and reception conditions for the USB host side apparatus after the data processing has ended. Thus, the connection with the USB host side apparatus is released beforehand when processing on data from the USB host side apparatus cannot be executed since processing on data from the USB device side apparatus is being executed, and the connection with the USB host side apparatus is restored when the data processing ends. Accordingly, wireless data communication with the USB host side apparatus or the USB device side apparatus can be smoothly performed. Here, the ‘execution period based on the period for which the data processing is executed’ may be the entire period for which the data processing is executed, a period including a preparatory period for which execution of the data processing is prepared, or a period in which a period for which processing on data from a device side apparatus is executed and a subsequent period for which transmission and reception of data from the host side are executed partially overlap each other.

In the USB device according to the aspect of the invention, the communication control unit may cause communication information on transmission and reception conditions for a non-connected USB device side apparatus to be stored in the information storage unit when a connection with the USB device side apparatus is established and cause the wireless unit to release a connection with the USB host side apparatus during the execution period including a period for which the connection with the USB device side apparatus is established. In this case, since communication information on the connected USB device side apparatus is stored, wireless data communication with the USB device side apparatus can be smoothly performed using the communication information later. Furthermore, since processing on data from the connected USB device side apparatus is often performed while a connection with the USB device side apparatus is maintained, data communication can be smoothly performed by prioritizing the connected apparatus.

In the USB device according to the aspect of the invention, the data processing executing unit may be a printing processing executing unit that performs printing processing on a print medium using printing processing data which is the processing data. In addition, the communication control unit may cause the wireless unit to release a connection with the USB host side apparatus during an execution period based on a period for which the wireless unit serving as a USB host receives printing processing data from the device side apparatus and the printing processing executing unit executes printing processing using the received printing processing data. In the printing processing, processing for printing a number of printing processing data cannot be executed in many cases. In this case, an application of the invention is meaningful.

In the USB device according to the aspect of the invention, the communication control unit may execute reboot processing on the USB device when causing the wireless unit to perform reconnection with the USB host side apparatus after releasing the connection with the USB host side apparatus. In this case, reconnection with the USB host side apparatus can be made by relatively simple processing using the reboot processing. The reboot processing means rebooting the USB device on the basis of communication information while a connection with the USB host is maintained before the connection with the USB device is established.

In the USB device according to the aspect of the invention, only one wireless unit may be provided. In this case, communication with the USB device side apparatus or the USB host side apparatus can be performed with a simple configuration.

According to another aspect of the invention, a printing apparatus includes: the USB device described above; and a printing processing executing unit serving as the data processing executing unit that performs printing processing on a print medium using printing processing data which is the processing data from the USB device. Since the printing apparatus includes the USB device described above, it is possible to obtain the same effects as in the USB device, for example, an effect that wireless data communication with the USB host side apparatus or the USB device side apparatus can be performed more smoothly.

According to still another aspect of the invention, a control method of a USB device that includes a wireless unit that wirelessly performs both transmission/reception of data to/from a USB host side apparatus and transmission/reception of data to/from a USB device side apparatus and that has functions of USB host and USB device includes: causing the wireless unit to release a connection with the USB host side apparatus during an execution period based on a period for which the wireless unit serving as a USB host transmits/receives predetermined processing data to/from the USB device side apparatus and predetermined data processing is executed by using the processing data; and causing the wireless unit to perform reconnection with the USB host side apparatus using communication information on transmission and reception conditions for the USB host side apparatus after the data processing has ended.

Also in the control method of a USB device, wireless data communication with the USB host side apparatus or the USB device side apparatus can be more smoothly performed. Moreover, in the control method of a USB device, various features of the USB device described above may be adopted or a process for realizing each function of the USB device may be added.

According to still another aspect of the invention, there is provided a program causing one or a plurality of computers (for example, CPUs) to realize the processes of the control method of a USB device described above. This program may be stored in computer-readable recording media (for example, a hard disk, a ROM, an FD, a CD, and a DVD), may be distributed to a computer, such as a server, through a transmission medium (communication network, such as Internet or LAN), or may be transmitted and received in other forms. Since each of the processes of the control method of a USB device described above is executed when the program is executed by one or a plurality of computers, the same operations and effects as the control method can be obtained.

### BRIEF DESCRIPTION OF THE DRAWINGS

The invention will be described with reference to the accompanying drawings, wherein like numbers reference like elements.

FIG. 1 is a block diagram schematically illustrating the configuration of a wireless USB system.

FIG. 2 is a flow chart illustrating an example of a dual role printer processing routine.

FIG. 3 is an explanatory view illustrating a wireless USB association screen.

FIG. 4 is an explanatory view illustrating an example of connection context information.

FIG. 5 is a flow chart illustrating a dual role digital camera processing routine.

### DESCRIPTION OF EXEMPLARY EMBODIMENTS

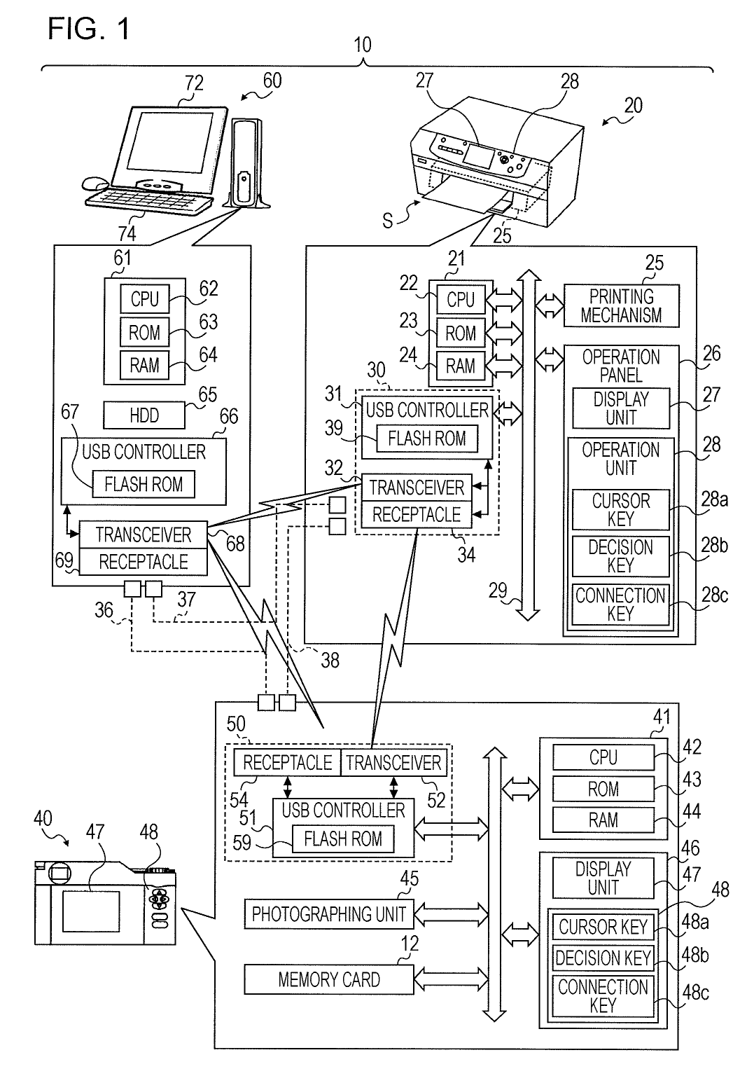

Hereinafter, an embodiment of the invention will be described with reference to the accompanying drawings. FIG. 1 is a block diagram schematically illustrating the configuration of a wireless USB system 10 that is an embodiment of the invention. The wireless USB system 10 according to the present embodiment is configured to include: a printer 20 that is a dual role device having functions as a USB host and a USB device and performs printing of print data and the like; a digital camera 40 that is a dual role device having functions as a USB host and a USB device and performs transmission of imaged image data and the like; and a user personal computer (PC) 60 that performs information exchange with the printer 20 and the digital camera 40 as USB hosts through a wireless USB. In addition, although the digital camera 40 in the present embodiment shows an example of a dual role device, the digital camera 40 may be configured to have only a USB device function.

The printer 20 includes a controller 21 that controls the entire device, a printing mechanism 25 that performs printing on recording paper S using ink as a coloring material, an operation panel 26 that can display information for a user and can input a user's instruction, and a USB device 30 that wirelessly transmits/receives data to/from an external apparatus (for example, the digital camera 40). The controller 21 is configured as a microprocessor mainly using a CPU 22 and includes a ROM 23 that stores various processing programs therein and a RAM 24 that temporarily stores data therein. The controller 21 is connected to the printing mechanism 25, the operation panel 26, the USB device 30, and the like through a bus 29. Although not shown, the printing mechanism 25 is an ink jet type mechanism that executes printing processing by applying pressure to ink of each color and discharging the pressed ink onto the recording paper S. In addition, a mechanism for applying the pressure to ink may use deformation of a piezoelectric element or generation of bubbles caused by heat of a heater. The USB device 30 is configured to include: a USB controller 31 that controls information exchange with an external apparatus connected to the USB device 30 wirelessly or by a cable; a transceiver 32 that wirelessly transmits/receives data to/from a USB host side apparatus or a USB device side apparatus; a receptacle 34 in which USB cables 37 and 38 are mounted; and a flash ROM 39 that can store information therein or delete information therefrom. The printer 20 has only one transceiver 32. The receptacle 34 may be used in a pair with the transceiver 32 and is configured as an AB type receptacle. In addition, the receptacle 34 may also be configured as either an A type receptacle or a B type receptacle. The operation panel 26 is a device used when a user inputs various instructions to the printer 20 and is configured to include a display unit 27, on which characters or images corresponding to various instructions are displayed, and an operation unit 28 that can input a user's instruction with various buttons. A cursor key 28a pressed when moving a cursor vertically and horizontally, a decision key 28b pressed when deciding an object to be selected, and a connection key 28c pressed when establishing a connection with an apparatus to communicate first are provided in the operation unit 28. Moreover, an A plug is provided at one end and a B plug is provided at the other end in each of USB cables 36, 37, and 38, and the USB cables 36, 37, and 38 are formed as cables that can be mounted in or demounted from a suitable receptacle.

The digital camera 40 includes: a controller 41 that executes various controls; a photographing unit 45 that converts incident light into an electrical signal by an imaging device (for example, a CMOS) and generates an image file; a memory card 12 into which an image file can be written and from which the image file can be deleted; an operation panel 46 provided with a display unit 47 capable of displaying information for a user thereon and an operation unit 48 capable of inputting a user's instruction; and a USB device 50 that wirelessly transmits/receives data to/from an external apparatus (for example, the printer 20). The controller 41 is configured as a microprocessor mainly using a CPU 42 and includes a ROM 43 that stores various processing programs therein and a RAM 44 that temporarily stores data therein. A cursor key 48a pressed when a user moves a cursor or the like, a decision key 48b pressed when deciding processing selection and the like, and a connection key 48c pressed when establishing a connection with an apparatus to communicate first are provided in the operation unit 48. The USB device 50 is configured to include: a USB controller 51 that controls information exchange with an external apparatus connected to the USB device 50 wirelessly or by a cable; a transceiver 52 that wirelessly transmits/receives data to/from a USB host side apparatus or a USB device side apparatus; a receptacle 54 in which the USB cables 36 and 37 are mounted; and a flash ROM 59 that can store information therein or delete information therefrom. The digital camera 40 has only one transceiver 52. The receptacle 54 is configured as an AB type receptacle since the receptacle 54 may be used as a pair together with the transceiver 52. In addition, the receptacle 54 may also be formed as either an A type receptacle or a B type receptacle. In addition, when the digital camera 40 is configured as a USB device, the receptacle 54 may be formed as a B type receptacle. The memory card 12 is a nonvolatile memory, into which data can be written and from which the data can be deleted, and stores a plurality of image files photographed by a photographing device, such as the digital camera 40.

The user PC 60 is a known general-purpose personal computer and includes: a controller 61 that includes a CPU 62 that executes various controls, a ROM 63 that stores various control programs therein, and a RAM 64 that temporarily stores data therein; an HDD 65 that is a large-capacity memory that stores various application programs or various data files; and a USB controller 66 that wirelessly transmits/receives data to/from an external apparatus (for example, the printer 20). A flash ROM 67 that stores information used at the time of transmission and reception of data is provided in the USB controller 66. A transceiver 68 that wirelessly executes transmission and reception of data as a USB host, a receptacle 69, and the like are electrically connected to the USB controller 66. In addition, the user PC 60 includes a display 72 that performs screen display of various kinds of information and an input device 74, such as a keyboard and a mouse, with which the user inputs various instructions. The user PC 60 has a function of executing an operation corresponding to a user's input operation when a user performs an input operation of a cursor displayed on the display 72 with the input device 74. The user PC 60 instructs the printer 20 to perform printing processing by an installed program or acquires image data stored in the digital camera 40.

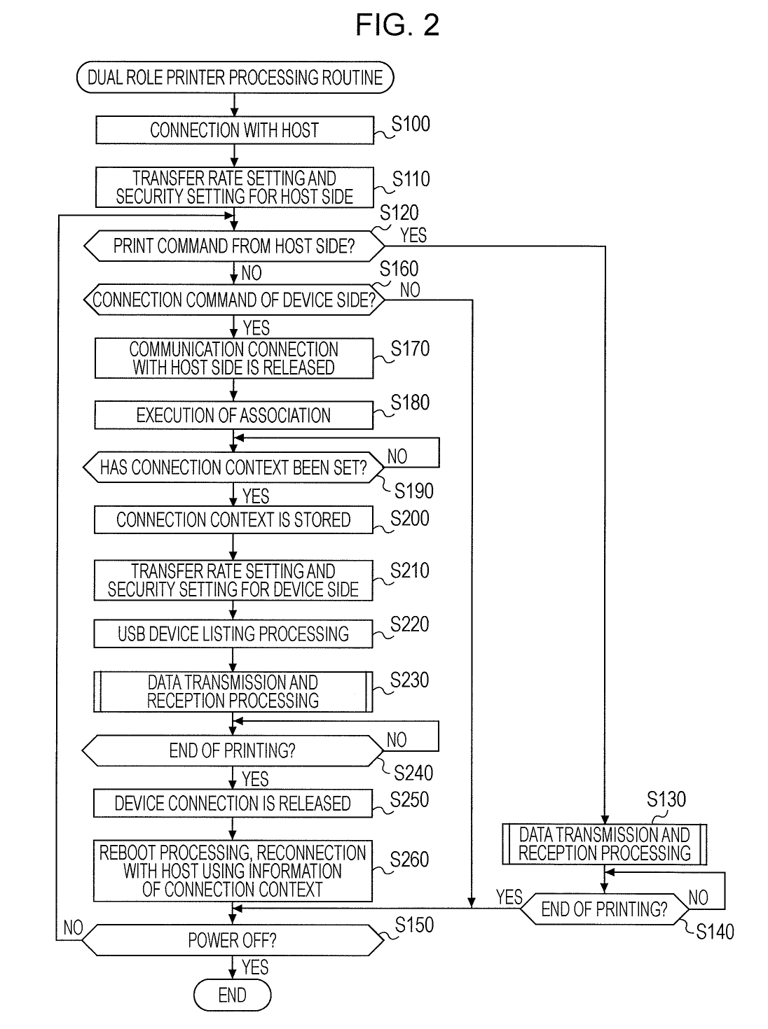

Next, an operation of the wireless USB system 10 according to the present embodiment configured as described above, in particular, an operation of the wireless USB system 10 when data is transmitted and received through a wireless USB and printing processing is performed by the printer 20 will be described. Here, the printer 20 and the user PC 60 are already connected (associated) to each other through a wireless USB, and processing of the printer 20 will be mainly described. First, the printer 20 and the user PC 60 are powered on. Then, the USB controller 31 of the printer 20 executes a dual role printer processing routine shown in FIG. 2. FIG. 2 is a flow chart illustrating an example of the dual role printer processing routine executed by the USB controller 31 of the printer 20. When this routine is executed, the USB controller 31 restores a connection with a USB host on the basis of connection context information stored at the time of association (step S100), performs transfer rate setting, security setting, and the like for the USB host side (step S110), and establishes a communication connection with the user PC 60. Here, information required for performing the association with the user PC 60, for example, IDs of host and device or security information is included in the connection context. In addition, it is assumed that the establishment of communication connection is performed by 4-way handshaking, for example. The 4-way handshaking may be performed in the following procedures, for example. Each of the USB host and the USB device has a CK (connection key) that is a master key. First, the USB host (user PC 60) transmits unique HNonce and TKID (temporal key identifier) to the USB device (printer 20) through the transceiver 68. Then, the USB controller 31 that has received the HNonce and the TKID generates a PTK (pairwise temporal key) on the basis of unique DNonce, HNonce, and CK, which are generated by itself and then checks whether or not the USB device has a correct PTK. The USB host generates a PTK on the basis of the DNonce which has received from the USB controller, HNonce, and CK. This is based on the fact that the same PTK is necessarily generated from HNonce and DNonce if the USB host and the USB device have the same CK. Then, the USB host notifies the USB device of the start of use of the PTK. Then, the USB device that has received the notice checks that the USB host has the correct PTK and notifies the USB host of the start of use of the PTK. Thus, encryption communication between the USB host and the USB device using the PTK can be performed. As described above, the communication connection between the USB host and the USB device can be established.

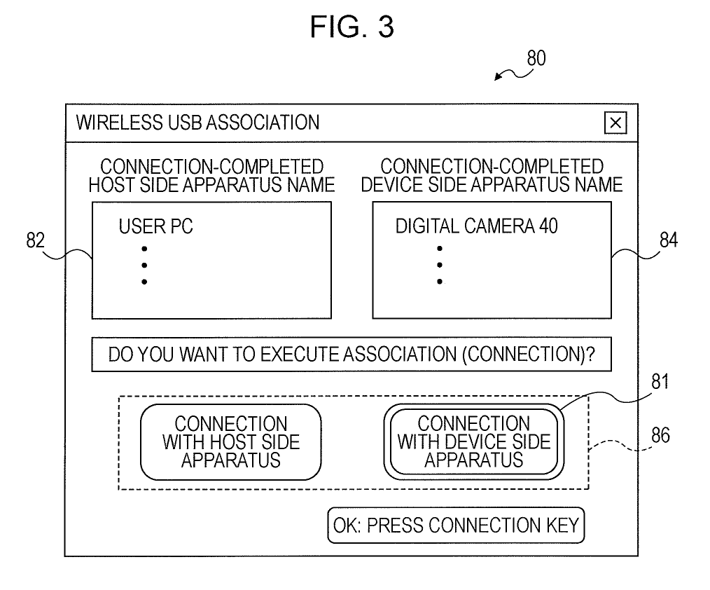

Here, association for establishing a communication connection between apparatuses with a wireless USB first will be described. Examples of the association include a USB cable method (out of band method) using a USB cable and a numeric method (in band method) using a transceiver of a wireless USB. In the USB cable method, one end (A type plug) of the USB cable 37 is mounted in the receptacle 69 and the other end (B type plug) of the USB cable 37 is mounted in the receptacle 34. Then, the USB controller 31 transmits descriptor of the USB device 30 to the USB controller 66 through the USB cable 37. Since the USB controller 66 that has received the descriptor stores the descriptor in the flash ROM 67 and information indicating a corresponding device of the wireless USB is included in the descriptor, the USB controller 66 exchanges the connection context through the USB cable 37 and then executes 4-way handshaking to set the wireless USB in a usable state. In addition, the descriptor may be stored in a nonvolatile storage region, such as the HDD 65. On the other hand, in the numeric method, for example, the user displays a wireless USB association screen 80 shown in FIG. 3 on the display unit 27 of the printer 20 to thereby start the association. A cursor 81 that is movable vertically and horizontally, a host side apparatus display portion 82 that displays an association-completed host side apparatus name, a device side apparatus display portion 84 that displays an association-completed device side apparatus name, and an apparatus type selection column 86 that selects whether an apparatus to be connected is on a host side or a device side are included on the wireless USB association screen 80, such that these apparatuses can be checked. At this time, the user also displays a screen for the start of the same association on the display 72 of the user PC 60. Then, the user clicks on a connection start button (not shown) on a screen of the display 72 and presses the connection key 28c of the printer 20 for connection with the host side apparatus using the cursor 81. Then, the USB controller 31 exchanges public keys (public key cryptography), which are digit sequences, with the USB controller 66, calculates hash values in both the USB host and the USB device on the basis of the public keys, and displays a 2-digit or 4-digit value, which can be displayed by the USB device, as a check value on the display unit 27. Moreover, the user PC 60 also displays the check value on the display 72 in a digit notified from the USB host. Here, the association succeeds when the same check value is displayed on the USB host and the USB device but fails when different values are displayed because association with a different host has been performed, for example. When the same check value has been checked in the USB host and the USB device, the user clicks on a connection check button (not shown) on a screen of the display 72 and presses the connection check button with the cursor 81. The USB controller 31 generates a CK (connection key) and stores the CK in the flash ROM 39 as a connection context together with a CHID (connection host ID) and a CDID (connection device ID). In addition, a region where a plurality of (at least one) connection contexts are stored is provided in the flash ROM 39. Then, 4-way handshaking is executed to set the wireless USB in a usable state. A list of apparatuses connected in the past is displayed on the basis of the connection context information stored in the flash ROM 39 on the host side apparatus display portion 82, which displays an association-completed host side apparatus name, and the device side apparatus display portion 84, which displays an association-completed device side apparatus name, of the USB association screen 80. When a connection with a USB host connected in the past is made, it is possible to restore the connection on the basis of corresponding connection context information by selecting the connected host from the host side apparatus display portion 82. Then, 4-way handshaking is executed to set the wireless USB in a usable state.

After step S110, the USB controller 66 of the user PC 60 performs USB device listing processing to recognize the printer 20. Then, the USB controller 31 determines whether or not a print command from the USB host side has been received (step S120). When it is determined that the print command has been received, the USB controller 31 causes the transceiver 32 to execute transmission and reception processing of print data wirelessly transmitted from the transceiver 68 (step S130) and determines whether or not the printing has ended (step S140). Here, the transmission and reception processing includes processing, such as transaction including token, data, and handshaking specified by a cable USB, in order to transmit and receive bulk data for reception of print data or transmission of printer status and data. The print data that the USB device 30 has received is stored in a predetermined region of the RAM 24. Moreover, in printing processing, the CPU 22 performs processing for expanding the print data stored in the RAM 24 to raster data, transporting the recording paper S by driving a driving motor (not shown) to rotate a transport roller, and printing an image on the recording paper S on the basis of the expanded raster data by controlling a voltage applied to a printing head. End of the printing processing is waited when the printing processing has not ended, and it is determined whether or not the power is turned off when the printing processing has ended (step S150). When the power is not turned off, processing from step S120 is executed. Thus, the printing processing is executed by receiving printing data wirelessly transmitted from the user PC 60.

On the other hand, when a print command from the host side is not received in step S120, it is determined whether or not there is a command of communication connection to the device side, that is, an association request (step S160). When there is no command of communication connection to the device side, processing from step S150 is executed. On the other hand, when there is a command of communication connection to the device side, the connection to the USB host side is released (step S170) and processing for association with the device side is executed (step S180). Disconnection from the USB host side apparatus may be performed, for example, by transmitting a device DN disconnect to the USB host side apparatus. Hereinafter, a case where association between the digital camera 40 and the printer 20 as USB device side apparatuses that are not associated is executed as a communication connection command will be described. In this case, the printer 20 serves as a USB device side apparatus with respect to the user PC 60 but serves as a USB host side apparatus with respect to the digital camera 40. For example, a case where the printer 20 reads and prints an image file stored in the digital camera 40 corresponds to the above case. First, when the association based on the USB cable method or the numeric method is executed by the user, the USB controller 31 waits until a connection context is set (step S190). When the connection context is set, the connection context is stored in connection context information 39a (step S200) and transfer rate setting and security setting for the device side are performed (step S210). Since the connection with the wireless USB is completed at this time, normal processing for USB device listing is then performed (step S220). Then, since the digital camera 40 is recognized, the device is configured such that communication with the USB device is possible.

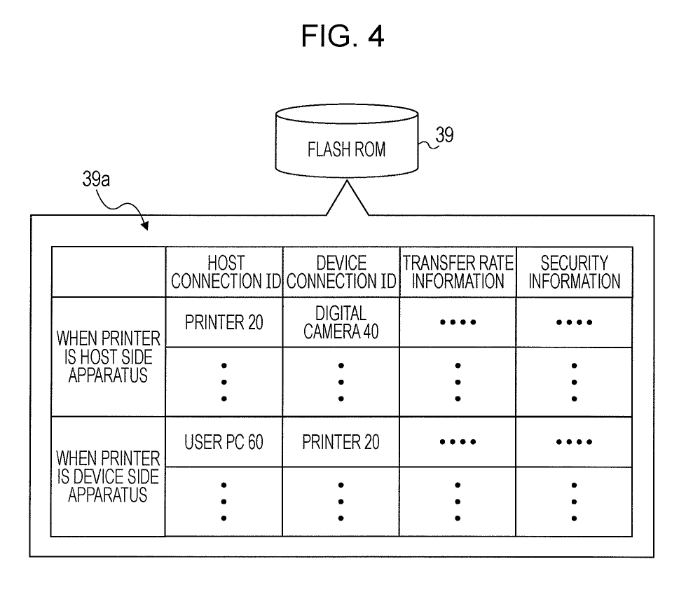

FIG. 4 is an explanatory view illustrating an example of the connection context information 39a stored in the flash ROM 39. Transfer rates, security information (for example, a cryptographic key), and the like to which association-completed host side apparatus and device side apparatus correspond are stored in the connection context information 39a. The same information as the connection context information 39a is also stored in the flash ROM 59 or the flash ROM 67. In addition, the CPU 22 may create the wireless USB association screen 80 using the connection context information 39a. Moreover, data transmission and reception in the wireless USB may be realized by performing the above-described processing according to steps S180 to S220 also in the case of executing a connection with an association-completed device side apparatus without being limited to the association described herein. When executing a connection using the stored connection context, a series of processing until a connection context is set can be skipped. After step S220, data transmission and reception processing, for example, processing for receiving data transmitted from the transceiver 52 of the digital camera 40 using the transceiver 32 is executed (step S230) and end of the printing processing is waited (step S240). In the meantime, the connection with the USB controller 66 is not made. When the printing processing ends in step S240, the communication connection with the device side apparatus is released (step S250), reboot processing (disconnection and connection processing based on a USB and a wireless USB) of the USB device 30 is executed, reconnection with the USB host is executed by using the connection context information 39a (step S260), and processing from step S150 is executed. When the power source is turned off in step S150, the routine ends. Thus, print data is not received from the USB host side apparatus by releasing the communication connection with the USB host during an execution period for which processing for printing the print data from the USB device side apparatus is executed, which is a period for which processing for printing other print data cannot be performed, and then the USB device 30 is rebooted to restore a connection with the USB host when the printing processing ends.

Here, the correspondence relationship between constituent components of the present embodiment and constituent components of the invention will be clarified. The USB device 30 of the present embodiment corresponds to a USB device of the invention, the user PC 60 corresponds to a USB host side apparatus, and the digital camera 40 corresponds to a USB device side apparatus. In addition, the transceiver 32 corresponds to a wireless unit. The controller 21 and the printing mechanism 25 correspond to a data processing executing unit and a printing processing executing unit, respectively. The USB controller 31 corresponds to a communication control unit and the flash ROM 39 corresponds to an information storage unit. In addition, the print data corresponds to processing data and printing processing data, the connection context information 39a corresponds to communication information, and the recording paper S corresponds to a print medium. Moreover, in the present embodiment, an example of a control method of a USB device of the invention is also clarified by describing the operation of the printer 20.

In the wireless USB system 10 according to the present embodiment described in detail above, a connection with a USB host side apparatus is released during the execution period for which processing for printing print data that the USB device 30 has received from a device side apparatus is executed, which is a period for which processing on data from the USB host side apparatus cannot be performed, and a communication connection with the USB host side apparatus is restored when the printing processing ends. As a result, wireless data communication between the USB host side apparatus and the USB device 30 and wireless data communication between the USB device side apparatus and the USB device 30 can be performed more smoothly. Furthermore, since descriptor of a connected USB device side apparatus is stored in the flash ROM 39, wireless data communication with the USB device side apparatus can be smoothly performed using the information later. Furthermore, since processing on data from the connected USB device side apparatus is often performed while the connection with the USB device side apparatus is maintained, data communication can be more smoothly performed by prioritizing the connected apparatus. Furthermore, in the printing processing, processing for printing a number of print data cannot be executed in many cases. In this case, an application of the invention is meaningful. Furthermore, reconnection with the USB host side apparatus can be made by relatively simple processing using reboot processing. Furthermore, since only one transceiver 32 is provided, communication with the USB device side apparatus or the USB host side apparatus can be performed with a simple configuration.

In addition, the invention is not limited to the above-described embodiment, but various modifications may be made within the scope without departing from the technical scope of the invention.

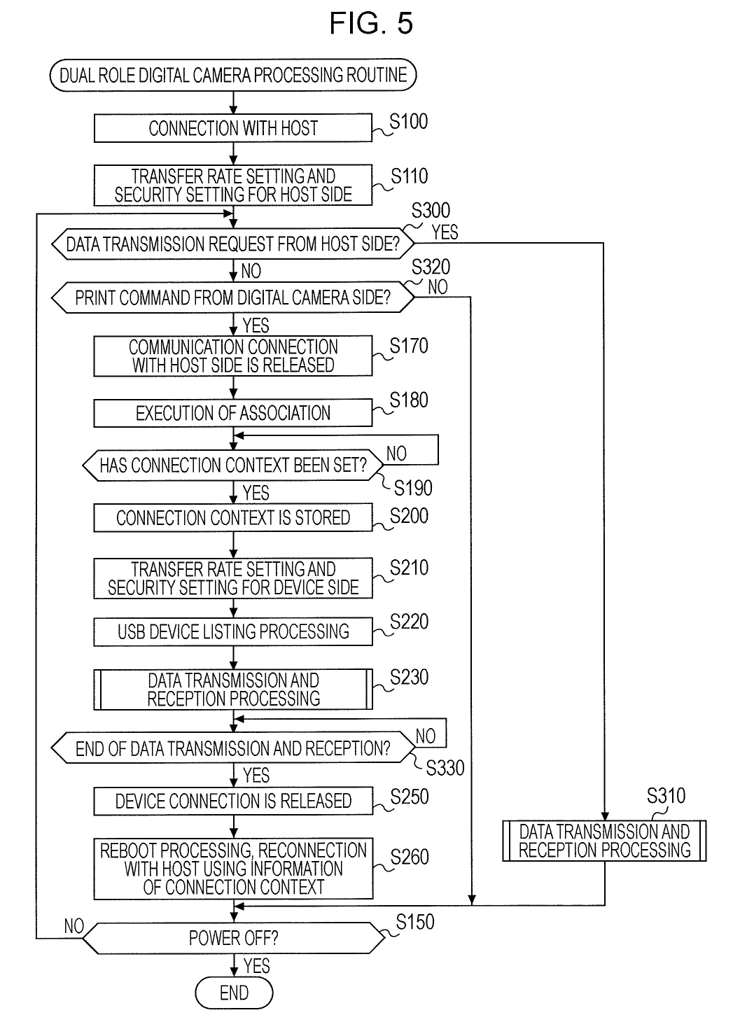

For example, although the printer 20 provided with the USB device of the invention is described in the above embodiment, an application to the digital camera 40 provided with the USB device of the invention may also be made. FIG. 5 is a flow chart illustrating an example of a dual role digital camera processing routine executed by the USB controller 51 of the digital camera 40. In addition, the same reference numeral is given to the same processing as the dual role printer processing routine described above and an explanation thereof will be omitted. Here, a case where the printer 20 makes a communication connection with the digital camera 40 as a USB device side apparatus and the digital camera 40 serves as a USB host when the user PC 60 is used as a USB host side apparatus and the digital camera 40 serves as a USB device will be specifically described. For example, a case where the digital camera 40 transmits an image file stored in the memory card 12 to the printer 20 and executes printing directly corresponds to the above case. The USB controller 51 of the digital camera 40 determines whether or not a data transmission request has been received from the host side apparatus (step S300) after executing the above-described processing in steps S100 and S110. When it is determined that the data transmission request has been received, the USB controller 51 performs data transmission and reception from the transceiver 52 to the transceiver 68 (step S310) and executes processing from step S150. On the other hand, when the data transmission request has not been received, it is determined whether or not there is a command to transmit print data (image data) from the digital camera 40 to the printer 20 and execute printing on the basis of whether or not a direct print button (not shown) has been pressed (step S320). When there is no print command, the above-described processing from step S150 is executed. When there is a print command, the above-described processing in steps S170 to S230 is executed. Then, end of transmission of the print data is waited (step S330) to execute processing from step S250. Also in this case, wireless data communication with the USB host side apparatus or wireless data communication with the USB device side apparatus can be performed more smoothly.

In the embodiment described above, a communication connection with a USB host side apparatus is released during the execution period including a period (period before print data is transmitted) for which execution of processing for printing print data from a USB device side apparatus is prepared. However, the communication connection with the USB host side apparatus may also be released during the execution period based on a period for which processing for printing print data from the USB device side apparatus is executed. For example, an entire period for which the printing processing is executed may be set as the execution period based on the period for which the printing processing is executed, or a period in which a period for which processing on data from a device side apparatus is executed and a subsequent period for which transmission and reception of print data from the host side are executed partially overlap each other may be set as the execution period based on the period for which the printing processing is executed. In this manner, since the next print data from the host device can be buffered in the RAM 24 immediately before printing of the print data from the device side apparatus ends, the printing processing can be executed more smoothly.

In the embodiment described above, one transceiver 32 used for both the USB host side and the USB device side is provided. However, two or more transceivers 32 used for both the USB host side and the USB device side may be provided. Also in this case, wireless data communication can be performed more smoothly even though the number of constituent components increases.

In the above embodiment, the printer 20 provided with the USB device 30 has been described. However, the invention may also be applied to a multifunction printer provided with the USB device 30 and a scanner or to a printing apparatus, such as a FAX provided with the USB device 30. In addition, the invention may also be applied to other electronic apparatuses, for example, a digital video and a game machine, without being limited to the printing apparatus. Furthermore, although the ink jet type printing mechanism 25 is used in the printer 20, a printing mechanism that adopts a color dot impact method, a color electrophotographic method, or a color thermal transfer method may also be used without being particularly limited to the ink jet type printing mechanism 25. Alternatively, a printing mechanism that adopts a monochrome dot impact method, a monochrome electrophotographic method, or a monochrome thermal transfer method may be used. Furthermore, although the USB device 30 provided in the printer 20 has been described in the above embodiment, the USB device 30 may be independently used. Alternatively, the invention may be realized as a control method of the USB device 30 or a program therefor.

What is claimed is:

1. A USB device having functions of USB host and USB device, comprising:
a wireless unit that wirelessly performs both transmission/reception of data to/from a USB host side apparatus and transmission/reception of data to/from a USB device side apparatus;
an information storage unit that stores communication information on transmission and reception conditions for the USB host side apparatus; and
a communication control unit that causes the wireless unit to release a connection with the USB host side apparatus during an execution period based on a period for which the wireless unit serving as a USB host transmits/receives predetermined processing data to/from the USB device side apparatus and a data processing executing unit executes predetermined data processing using the processing data and that causes the wireless unit to perform reconnection with the USB host side apparatus using the communication information stored in the information storage unit after the data processing executing unit has ended the data processing.

2. The USB device according to claim 1,
wherein the communication control unit causes communication information on transmission and reception conditions for a non-connected USB device side apparatus to be stored in the information storage unit when a connection with the USB device side apparatus is established and causes the wireless unit to release a connection with the USB host side apparatus during the execution period including a period for which the connection with the USB device side apparatus is established.

3. The USB device according to claim 1,
wherein the data processing executing unit is a printing processing executing unit that performs printing processing on a print medium using printing processing data which is the processing data, and
the communication control unit causes the wireless unit to release a connection with the USB host side apparatus during an execution period based on a period for which the wireless unit serving as a USB host receives printing processing data from the device side apparatus and the printing processing executing unit executes printing processing using the received printing processing data.

4. The USB device according to claim 1,
wherein the communication control unit executes reboot processing on the USB device when causing the wireless unit to perform reconnection with the USB host side apparatus after releasing the connection with the USB host side apparatus.

5. The USB device according to claim 1,
wherein only one wireless unit is provided.

6. A printing apparatus comprising:
the USB device according to claim 1; and
a printing processing executing unit serving as the data processing executing unit that performs printing processing on a print medium using printing processing data which is the processing data from the USB device.

7. A control method of a USB device that includes a wireless unit that wirelessly performs both transmission/reception of data to/from a USB host side apparatus and transmission/reception of data to/from a USB device side apparatus and that has functions of USB host and USB device, the control method comprising:
causing the wireless unit to release a connection with the USB host side apparatus during an execution period based on a period for which the wireless unit serving as a USB host transmits/receives predetermined processing data to/from the USB device side apparatus and predetermined data processing is executed by using the processing data; and
causing the wireless unit to perform reconnection with the USB host side apparatus using communication information on transmission and reception conditions for the USB host side apparatus after the data processing has ended.

8. A program causing one or more computers to execute the processes of the control method of a USB device according to claim 7.
